(19) United States
(12) Patent Application Publication
(10) Pub. No.: US 2023/0247991 A1
(43) Pub. Date: Aug. 10, 2023

(54) ANTIMICROBIAL MIXTURE CONTAINING 4-(3-ETHOXY-4-HYDROXYPHENYL)BUTAN-2-ONE AND AN ORGANIC ACID COMPOUND, AND COSMETIC COMPOSITION CONTAINING SAME

(71) Applicant: L'OREAL, Paris (FR)

(72) Inventors: Florence MENARD-SZCZEBARA, Chevilly Larue (FR); Sylvie Cupferman, Chevilly Larue (FR); Julien Galvan, Chevilly Larue (FR)

(21) Appl. No.: 18/298,500

(22) Filed: Apr. 11, 2023

Related U.S. Application Data
(63) Continuation of application No. 16/625,281, filed on Dec. 20, 2019, now abandoned.

(30) Foreign Application Priority Data
Jun. 30, 2017 (FR) 1756157
Jun. 30, 2017 (FR) 1756160
Jun. 30, 2017 (FR) 1756162
Jun. 30, 2017 (FR) 1756168
Jun. 30, 2017 (FR) 1756172
Nov. 10, 2017 (FR) 1760573

(51) Int. Cl. A01N 37/10; A01N 33/08; A01N 33/12; A01N 35/02; A01N 37/06; A01N 37/28; A01N 59/00

(52) U.S. Cl. CPC A01N 37/10; A01N 33/08; A01N 33/12; A01N 35/02; A01N 37/06; A01N 37/28; A01N 59/00

(57) ABSTRACT

The invention relates to an antimicrobial mixture containing 4-(3-ethoxy-4-hydroxyphenyl)butan-2-one and an organic acid compound chosen from a benzoic acid salt, sorbic acid or a salt thereof, methyl 4-hydroxybenzoate, propyl 4-hydroxybenzoate, 5-n-octanoylsalicylic acid, a hydroxamic acid and dehydroacetic acid or a salt thereof, and also to a cosmetic composition containing such a mixture. Use in caring for, making up and cleansing keratin materials.

### CROSS-REFERENCE TO RELATED APPLICATIONS

This application claims priority to and is a continuation of U.S. patent application Ser. No. 16/625,281, filed on Jun. 27, 2018, which is a National Phase filing under 35 U.S.C. § 371 of PCT/EP2018/067297 filed on Jun. 27, 2018; which application in turn claims priority to Application No. 1756157 filed in France on Jun. 30, 2017; to Application No. 1756160 filed in France on Jun. 30, 2017; to Application No. 1756162 filed in France on Jun. 30, 2017; to Application No. 1756168 filed in France on Jun. 30, 2017; to Application No. 1756172 filed in France on Jun. 30, 2017; and to Application No. 1760573 filed in France on Nov. 10, 2017. The entire contents of each application are hereby incorporated by reference.

The subject of the present invention is an antibacterial mixture containing 4-(3-ethoxy-4-hydroxyphenyl)butan-2-one and a particular organic acid compound, and also a cosmetic composition containing such a mixture.

4-(3-Ethoxy-4-hydroxyphenyl)butan-2-one (ketone compound) is an interesting substance as a preserving agent for cosmetic compositions, for protecting the compositions against microbial contamination, as described in the application WO 2011/039445.

However, it is desirable to be able to incorporate said ketone compound in reduced concentration in compositions, especially cosmetic or dermatological compositions, while at the same time maintaining good antimicrobial conservation performance. Combinations of the ketone compound with other compounds that have an antimicrobial efficacy are thus sought for this purpose.

The inventors have discovered, unexpectedly, that the combination of 4-(3-ethoxy-4-hydroxyphenyl)butan-2-one with an organic acid compound chosen from a benzoic acid salt, such as sodium benzoate, sorbic acid or a salt thereof, methyl 4-hydroxybenzoate, propyl 4-hydroxybenzoate, 5-n-octanoylsalicylic acid, a hydroxamic acid, dehydroacetic acid or a salt thereof, as defined below, makes it possible to obtain an antimicrobial mixture which has synergistic antimicrobial activity.

The results of the examples described below show the synergistic antimicrobial activity obtained with the minimum inhibitory concentration (MIC) measurements taken with several mixtures. The antimicrobial activity is considered as being synergistic when the antimicrobial mixture makes it possible to obtain a percentage of strain growth of less than or equal to 20%, or even less than or equal to 25%.

The combination of 4-(3-ethoxy-4-hydroxyphenyl)butan-2-one with a benzoic acid salt such as sodium benzoate makes it possible to obtain an antimicrobial mixture which has synergistic antimicrobial activity, in particular on yeasts, in particular on Candida albicans, on gram-negative bacteria, in particular on Pseudomonas aeruginosa, and on gram-positive bacteria, in particular on Staphylococcus aureus.

The combination of 4-(3-ethoxy-4-hydroxyphenyl)butan-2-one with sorbic acid or a salt thereof makes it possible to obtain an antimicrobial mixture which has synergistic antimicrobial activity, in particular on moulds, in particular on Aspergillus niger, and on gram-positive bacteria, in particular on Enterococcus faecalis. Furthermore, the mixture with sorbic acid also has synergistic antimicrobial activity on yeasts, in particular on Candida albicans, and on the gram-positive bacterium Staphylococcus aureus.

The combination of 4-(3-ethoxy-4-hydroxyphenyl)butan-2-one with methyl 4-hydroxybenzoate or propyl 4-hydroxybenzoate makes it possible to obtain an antimicrobial mixture which has synergistic antimicrobial activity, in particular on yeasts, in particular on Candida albicans, and on gram-negative bacteria, in particular on Pseudomonas aeruginosa. Furthermore, the mixture with methyl 4-hydroxybenzoate also has synergistic antimicrobial activity on gram-positive bacteria, in particular on Staphylococcus aureus and on Enterococcus faecalis. This result is surprising since, on the one hand, the mixture of 4-(3-ethoxy-4-hydroxyphenyl)butan-2-one with ethyl 4-hydroxybenzoate and, on the other hand, the mixture of 4-(3-ethoxy-4-hydroxyphenyl)butan-2-one with butyl 4-hydroxybenzoate have no synergistic antimicrobial activity.

The combination of 4-(3-ethoxy-4-hydroxyphenyl)butan-2-one with 5-n-octanoylsalicylic acid makes it possible to obtain an antimicrobial mixture which has synergistic antimicrobial activity, in particular on moulds, in particular on Aspergillus niger, and on gram-positive bacteria, in particular on Enterococcus faecalis. Furthermore, the mixture with 5-n-octanoylsalicylic acid also has synergistic antimicrobial activity on yeasts, in particular on Candida albicans, and on the gram-positive bacterium Staphylococcus aureus.

The combination of 4-(3-ethoxy-4-hydroxyphenyl)butan-2-one with a hydroxamic acid as defined below, in particular caprylhydroxamic acid, makes it possible to obtain an antimicrobial mixture with synergistic antimicrobial activity, in particular on moulds, especially on Aspergillus niger.

The combination of 4-(3-ethoxy-4-hydroxyphenyl)butan-2-one with dehydroacetic acid or a salt thereof, in particular sodium dehydroacetate, makes it possible to obtain an antimicrobial mixture which has synergistic antimicrobial activity, in particular on moulds, in particular on Aspergillus niger, and on yeasts, in particular on Candida albicans.

More precisely, a subject of the invention is an antimicrobial mixture comprising, or constituted of, 4-(3-ethoxy-4-hydroxyphenyl)butan-2-one and an organic acid compound chosen from:

i) a benzoic acid salt;
ii) sorbic acid or a salt thereof;
iii) methyl 4-hydroxybenzoate or propyl 4-hydroxybenzoate;
iv) 5-n-octanoylsalicylic acid;
v) a hydroxamic acid or a salt thereof, of formula (I):

R—C(═O)—NH—OH (I)

in which R represents a linear or branched, saturated or unsaturated C₅ to C₁₁ alkyl radical;
vi) dehydroacetic acid or a salt thereof.

The term “organic acid compound” is intended to mean the compounds mentioned previously which may be a carboxylic acid, a carboxylic acid salt or a carboxylic acid ester.

A subject of the invention is also a composition, in particular a cosmetic or dermatological composition, comprising, in a physiologically acceptable medium, said mixture described previously.

A further subject of the invention is a process for the non-therapeutic cosmetic treatment of keratin materials, comprising the application to the keratin materials of a composition as described previously. The process may be a cosmetic process for caring for or making up or cleansing keratin materials.

A subject of the invention is also a process for conserving a composition comprising a physiologically acceptable medium, in particular a cosmetic or dermatological composition, characterized in that it consists in incorporating into said composition an antimicrobial mixture as described previously.

A subject of the invention is also the use of the antimicrobial mixture described previously for conserving a composition comprising a physiologically acceptable medium.

4-(3-Ethoxy-4-hydroxyphenyl)butan-2-one is a compound of formula

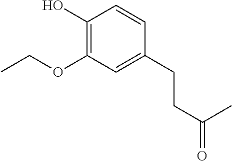

According to a first embodiment, a subject of the invention is an antimicrobial mixture comprising, or constituted of, 4-(3-ethoxy-4-hydroxyphenyl)butan-2-one and a benzoic acid salt.

The benzoic acid salt may be chosen from alkali metal (sodium, potassium) salts, alkaline-earth metal (calcium, magnesium) salts or monoethanolamine or ammonium salts. Preferably, it is the sodium salt: sodium benzoate.

Advantageously, 4-(3-ethoxy-4-hydroxyphenyl)butan-2-one and the benzoic acid salt are present in said mixture in a content such that the 4-(3-ethoxy-4-hydroxyphenyl)butan-2-one/benzoic acid salt weight ratio ranges from 0.1 to 3, preferably ranges from 0.1 to 1.5, preferentially ranging from 0.2 to 1.5 and more preferentially ranging from 0.2 to 1.2.

The antimicrobial mixture may have a 4-(3-ethoxy-4-hydroxyphenyl)butan-2-one/benzoic acid salt weight ratio ranging from 0.2 to 3, preferably ranging from 0.2 to 2.2 and preferentially ranging from 0.2 to 1.5. Such a mixture has good antimicrobial activity on the gram-positive bacterium Staphylococcus aureus.

The antimicrobial mixture may have a 4-(3-ethoxy-4-hydroxyphenyl)butan-2-one/benzoic acid salt weight ratio ranging from 0.2 to 1.5, preferably ranging from 0.2 to 0.7. Such a mixture has good antimicrobial activity on yeasts, in particular on Candida albicans.

The antimicrobial mixture may have a 4-(3-ethoxy-4-hydroxyphenyl)butan-2-one/benzoic acid salt weight ratio ranging from 0.1 to 1.5, preferably ranging from 0.1 to 1.1. Such a mixture has good antimicrobial activity on gram-negative bacteria, in particular on Pseudomonas aeruginosa.

According to a second embodiment, a subject of the invention is an antimicrobial mixture comprising, or constituted of, 4-(3-ethoxy-4-hydroxyphenyl)butan-2-one and sorbic acid or a salt thereof.

Sorbic acid corresponds to the compound hexa-2,4-dienoic acid (CAS No.: 110-44-1) of formula CH₃—CH═CH—CH═CH—COOH.

The sorbic acid salts may be chosen from alkali metal (sodium, potassium) salts, alkaline-earth metal (calcium, magnesium) salts or triethanolamine salts. Preferably, it is the potassium salt:potassium sorbate.

Advantageously, 4-(3-ethoxy-4-hydroxyphenyl)butan-2-one and sorbic acid or a salt thereof are present in said mixture in a content such that the weight ratio of 4-(3-ethoxy-4-hydroxyphenyl)butan-2-one/sorbacid or a salt thereof ranges from 0.1 to 2.5, preferably ranging from 0.1 to 1.5, preferentially ranging from 0.2 to 1.5 and more preferentially ranging from 0.2 to 1.2.

The antimicrobial mixture according to the invention has synergistic antimicrobial activity, in particular on moulds, especially on Aspergillus niger, and on gram-positive bacteria, in particular on Enterococcus faecalis. Furthermore, the mixture with sorbic acid also has synergistic antimicrobial activity on yeasts, in particular on Candida albicans, and on the gram-positive bacterium Staphylococcus aureus.

According to a first variant of implementation of the invention, the antimicrobial mixture comprises sorbic acid.

The antimicrobial mixture may have a 4-(3-ethoxy-4-hydroxyphenyl)butan-2-one/sorbic acid weight ratio ranging from 0.1 to 1.5, and preferably ranging from 0.2 to 1.2. Such a mixture has good antimicrobial activity on the gram-positive bacterium Staphylococcus aureus.

The antimicrobial mixture may have a 4-(3-ethoxy-4-hydroxyphenyl)butan-2-one/sorbic acid weight ratio ranging from 0.1 to 1.5, preferably ranging from 0.4 to 1.2. Such a mixture has good antimicrobial activity on yeasts, in particular on Candida albicans.

The antimicrobial mixture may have a 4-(3-ethoxy-4-hydroxyphenyl)butan-2-one/sorbic acid weight ratio ranging from 0.1 to 0.8, preferably ranging from 0.2 to 0.6. Such a mixture has good antimicrobial activity on moulds, especially on Aspergillus niger.

The antimicrobial mixture may have a 4-(3-ethoxy-4-hydroxyphenyl)butan-2-one/sorbic acid weight ratio ranging from 0.15 to 0.4, preferably ranging from 0.2 to 0.3. Such a mixture has good antimicrobial activity on the gram-positive bacterium Enterococcus faecalis.

According to a second variant of implementation of the invention, the antimicrobial mixture comprises potassium sorbate.

The antimicrobial mixture may have a 4-(3-ethoxy-4-hydroxyphenyl)butan-2-one/potassium sorbate weight ratio ranging from 0.1 to 1.5, preferably from 0.1 to 1.2. Such a mixture has good antimicrobial activity on the gram-positive bacterium Enterococcus faecalis.

The antimicrobial mixture may have a 4-(3-ethoxy-4-hydroxyphenyl)butan-2-one/potassium sorbate weight ratio ranging from 0.3 to 2.5, preferably ranging from 0.3 to 1.5. Such a mixture has good antimicrobial activity on moulds, especially on Aspergillus niger.

According to a third embodiment, a subject of the invention is an antimicrobial mixture comprising, or constituted of, 4-(3-ethoxy-4-hydroxyphenyl)butan-2-one and a 4-hydroxybenzoic acid ester chosen from methyl 4-hydroxybenzoate and propyl 4-hydroxybenzoate.

The 4-hydroxybenzoic acid ester, subsequently referred to as “ester compound”, is chosen from methyl 4-hydroxybenzoate and propyl 4-hydroxybenzoate.

Advantageously, 4-(3-ethoxy-4-hydroxyphenyl)butan-2-one and the ester compound are present in said mixture in a content such that the 4-(3-ethoxy-4-hydroxyphenyl)butan-2-one/ester compound weight ratio ranges from 0.3 to 5, preferably ranges from 0.4 to 4.5.

The antimicrobial mixture according to the invention has synergistic antimicrobial activity, in particular on yeasts, in particular on Candida albicans, and on gram-negative bacteria, in particular on Pseudomonas aeruginosa. Furthermore, the mixture with methyl 4-hydroxybenzoate also has synergistic antimicrobial activity on gram-positive bacteria, in particular on Staphylococcus aureus and on Enterococcus faecalis.

According to a first variant of implementation of the invention, the antimicrobial mixture comprises methyl 4-hydroxybenzoate.

The antimicrobial mixture may have a 4-(3-ethoxy-4-hydroxyphenyl)butan-2-one/methyl 4-hydroxybenzoate weight ratio ranging from 0.1 to 1.5, preferably ranging from 0.2 to 1.5 and preferentially ranging from 0.4 to 1.2. Such a mixture has good antimicrobial activity on yeasts, in particular on Candida albicans.

The antimicrobial mixture may have a 4-(3-ethoxy-4-hydroxyphenyl)butan-2-one/methyl 4-hydroxybenzoate weight ratio ranging from 0.4 to 3, preferably ranging from 0.4 to 2.2. Such a mixture has good antimicrobial activity on gram-negative bacteria, especially on Pseudomonas aeruginosa.

The antimicrobial mixture may have a 4-(3-ethoxy-4-hydroxyphenyl)butan-2-one/methyl 4-hydroxybenzoate weight ratio ranging from 0.1 to 0.8, preferably ranging from 0.1 to 0.6. Such a mixture has good antimicrobial activity on the gram-positive bacterium Staphylococcus aureus.

The antimicrobial mixture may have a 4-(3-ethoxy-4-hydroxyphenyl)butan-2-one/methyl 4-hydroxybenzoate weight ratio ranging from 0.1 to 1.5. Such a mixture has good antimicrobial activity on the gram-positive bacterium Enterococcus faecalis.

According to a second variant of implementation of the invention, the antimicrobial mixture comprises propyl 4-hydroxybenzoate.

The antimicrobial mixture may have a 4-(3-ethoxy-4-hydroxyphenyl)butan-2-one/propyl 4-hydroxybenzoate weight ratio ranging from 0.3 to 1.5, preferably ranging from 0.4 to 1.2. Such a mixture has good antimicrobial activity on yeasts, in particular on Candida albicans.

The antimicrobial mixture may have a 4-(3-ethoxy-4-hydroxyphenyl)butan-2-one/propyl 4-hydroxybenzoate weight ratio ranging from 0.7 to 5, preferably from 0.8 to 4.5. Such a mixture has good antimicrobial activity on gram-negative bacteria, especially on Pseudomonas aeruginosa.

According to a fourth embodiment, a subject of the invention is an antimicrobial mixture comprising, or constituted of, 4-(3-ethoxy-4-hydroxyphenyl)butan-2-one and 5-n-octanoylsalicylic acid.

5-n-Octanoylsalicylic acid is also called capryloylsalicylic acid. It corresponds to the compound CAS No. 78418-01-6.

Advantageously, 4-(3-ethoxy-4-hydroxyphenyl)butan-2-one and 5-n-octanoylsalicylic acid or a salt thereof are present in said mixture in a content such that the 4-(3-ethoxy-4-hydroxyphenyl)butan-2-one/5-n-octanoylsalicylic acid weight ratio ranges from 0.5 to 60, preferably from 0.5 to 50, preferentially ranging from 0.5 to 45.

The antimicrobial mixture according to the invention has synergistic antimicrobial activity, in particular on moulds, especially on Aspergillus niger, on yeasts, in particular on Candida albicans, and on gram-positive bacteria, in particular on Enterococcus faecalis.

The antimicrobial mixture may have a 4-(3-ethoxy-4-hydroxyphenyl)butan-2-one/5-n-octanoylsalicylic acid weight ratio ranging from 3 to 12, preferably ranging from 3 to 10. Such a mixture has synergistic antimicrobial activity on moulds, especially on Aspergillus niger.

The antimicrobial mixture may have a 4-(3-ethoxy-4-hydroxyphenyl)butan-2-one/5-n-octanoylsalicylic acid weight ratio ranging from 0.5 to 12, preferably ranging from 0.5 to 10. Such a mixture has synergistic antimicrobial activity on yeasts, especially on Candida albicans.

The antimicrobial mixture may have a 4-(3-ethoxy-4-hydroxyphenyl)butan-2-one/5-n-octanoylsalicylic acid weight ratio ranging from 7 to 60, preferably ranging from 8 to 50 and preferentially ranging from 9 to 45. Such a mixture has synergistic antimicrobial activity on the gram-positive bacterium Enterococcus faecalis.

According to a fifth embodiment, a subject of the invention is an antimicrobial mixture comprising, or constituted of, 4-(3-ethoxy-4-hydroxyphenyl)butan-2-one and a hydroxamic acid, or a salt thereof, of formula (I):

R—C(═O)—NH—OH (I)

in which R represents a linear or branched, saturated or unsaturated C₅ to C₁₁ alkyl radical.

The hydroxamic acids under consideration according to the invention are compounds of general formula (I):

R—C(═O)—NH—OH (I)

in which:
R represents a linear or branched, saturated or unsaturated C₅-C₁₁ alkyl radical.
These compounds may be obtained via any method known to those skilled in the art, for example according to the preparation processes described in document WO 2009/070736.

According to one embodiment, the hydroxamic acids according to the invention are more particularly chosen from caprohydroxamic acid, caprylhydroxamic acid, caprihydroxamic acid and laurylhydroxamic acid, or mixtures thereof.

The salts of the hydroxamic acids of formula (I) may be chosen from alkali metal or alka-line-earth metal salts such as sodium, potassium, calcium or magnesium salts, or ammonium salts.

According to one preferred embodiment, the hydroxamic acid used in a composition in accordance with the invention is caprylhydroxamic acid.

Advantageously, 4-(3-ethoxy-4-hydroxyphenyl)butan-2-one and the hydroxamic acid (I) may be present in said mixture in contents such that the 4-(3-ethoxy-4-hydroxyphenyl)butan-2-one/hydroxamic acid (I) (preferably caprylhydroxamic acid) weight ratio ranges from 4 to 150, preferably from 30 to 130, preferentially from 45 to 130, more preferentially ranges from 60 to 130, in particular ranges from 90 to 130, and in particular ranges from 95 to 120.

Advantageously, the antimicrobial mixture comprises 1,3-propanediol, in particular according to a 1,3-propanediol/hydroxamic acid (I) weight ratio ranging from 5 to 20, preferably ranging from 8 to 17, and better still ranging from 10 to 15.

The antimicrobial mixture according to the invention has synergistic antimicrobial activity, in particular on moulds, especially on Aspergillus niger.

Preferentially, the antimicrobial mixture according to the invention contains caprylhydroxamic acid.

According to one preferred embodiment, the antimicrobial mixture contains hydroxamic acid and 1,3-propanediol. Preferably, such a mixture has a 1,3-propanediol/caprylhydroxamic acid weight ratio ranging from 5 to 20, preferably ranging from 8 to 17, and better still ranging from 10 to 15.

According to a sixth embodiment, a subject of the invention is an antimicrobial mixture comprising, or constituted of, 4-(3-ethoxy-4-hydroxyphenyl)butan-2-one and dehydroacetic acid or a salt thereof.

Dehydroacetic acid corresponds to the compound:

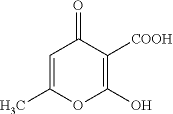

The dehydroacetic acid salts may be chosen from alkali metal (sodium, potassium) salts. Preferably, it is the sodium salt: sodium dehydroacetate.

Advantageously, 4-(3-ethoxy-4-hydroxyphenyl)butan-2-one and dehydroacetic acid or a salt thereof are present in said mixture in a content such that the weight ratio of 4-(3-ethoxy-4-hydroxyphenyl)butan-2-one/dehydroacetic acid or a salt thereof (preferably sodium dehydroacetate) ranges from 4 to 60, preferably ranging from 5 to 50.

The antimicrobial mixture according to the invention has synergistic antimicrobial activity, in particular on moulds, especially on Aspergillus niger, and on yeasts, in particular on Candida albicans.

Preferentially, the antimicrobial mixture according to the invention contains sodium dehydroacetate.

The antimicrobial mixture may have a 4-(3-ethoxy-4-hydroxyphenyl)butan-2-one/sodium dehydroacetate weight ratio ranging from 10 to 60, preferably ranging from 15 to 50. Such a mixture has good antimicrobial activity on yeasts, in particular on Candida albicans.

The antimicrobial mixture may have a 4-(3-ethoxy-4-hydroxyphenyl)butan-2-one/sodium dehydroacetate weight ratio ranging from 4 to 40, preferably ranging from 5 to 30. Such a mixture has good antimicrobial activity on moulds, especially on Aspergillus niger.

A subject of the invention is also a composition comprising, in a physiologically acceptable medium, the antimicrobial mixture described previously.

The term “physiologically acceptable medium” means a medium that is compatible with human keratin materials such as the skin, the scalp, the hair and the nails. Said medium may comprise one or more additional ingredients other than the organic acid compound described previously.

The compound 4-(3-ethoxy-4-hydroxyphenyl)butan-2-one may be present in the composition according to the invention at an amount ranging from 0.01% to 5% by weight relative to the total weight of the composition, preferably ranging from 0.01% to 3% by weight, preferentially ranging from 0.01% to 2.5% by weight and more preferentially ranging from 0.01% to 2% by weight.

A subject of the invention is also a composition comprising, in a physiologically acceptable medium, the antimicrobial mixture described previously.

The term “physiologically acceptable medium” means a medium that is compatible with human keratin materials such as the skin, the scalp, the hair and the nails. Said medium may comprise one or more additional ingredients other than the ketone compound or the organic acid compound described previously.

The composition may comprise at least one additional ingredient chosen from water, oils, polyols containing from 2 to 10 carbon atoms, gelling agents, surfactants, film-forming polymers, colorants, fragrances, fillers, UV-screening agents, plant extracts, cosmetic and dermatological active agents, and salts.

The composition according to the invention may comprise an aqueous phase.

The composition may comprise water, which may be present at a content ranging from 5% to 90% by weight relative to the total weight of the composition, and preferably ranging from 35% to 75% by weight.

The composition may also comprise a polyol that is water-miscible at ambient temperature (25° C.), especially chosen from polyols especially containing from 2 to 10 carbon atoms, preferably containing from 2 to 6 carbon atoms, such as glycerol, propylene glycol, 1,3-propanediol, butylene glycol, pentylene glycol, hexylene glycol, dipropylene glycol, diethylene glycol or digylcerol. Advantageously, the composition according to the invention comprises 1,3-propanediol, especially in a content ranging from 0.1% to 20% by weight, preferably ranging from 0.1% to 10% by weight and preferentially ranging from 0.5% to 5% by weight, relative to the total weight of the composition.

The compositions according to the invention may be in the form of oil-in-water (O/W) emulsions, water-in-oil (W/O) emulsions or multiple emulsions (triple: W/O/W or O/W/O), oily solutions, oily gels, aqueous solutions, aqueous gels, solid compositions. These compositions are prepared according to the usual methods.

The compositions according to the invention may be more or less fluid and may have the appearance of a white or coloured cream, an ointment, a milk, a lotion, a serum, a paste or a foam. They may be optionally applied to the skin in aerosol form. They may also be in solid form, for example in the form of a stick or a compact powder.

The composition according to the invention may especially be in the form of:
a makeup product, especially for making up the skin of the face, the body, or the lips or the eyelashes;
an aftershave gel or lotion; a shaving product;
a deodorant (stick, roll-on or aerosol);
a hair-removing cream;
a body hygiene composition such as a shower gel or a shampoo;
a pharmaceutical composition;
a solid composition such as a soap or a cleansing bar;
an aerosol composition also comprising a pressurized propellant;
a hairsetting lotion, a hair-styling cream or gel, a dye composition, a permanent-waving composition, a lotion or a gel for combating hair loss, or a hair conditioner;
a composition for caring for or cleansing the skin.

A subject of the invention is also a process for preparing a composition, in particular a cosmetic or dermatological composition, comprising a step of mixing 4-(3-ethoxy-4-hydroxyphenyl)butan-2-one, the organic acid compound described previously, and one or more additional ingredients, especially cosmetic or dermatological ingredients, such as those described previously.

The invention is illustrated in greater detail in the example that follows. The amounts of the ingredients are expressed as weight percentages.

### EXAMPLE 1: DETERMINATION OF THE SYNERGISTIC ANTIMICROBIAL ACTIVITY AS MIC

The demonstration of a synergistic antimicrobial activity effect with a mixture of 4-(3-ethoxy-4-hydroxyphenyl)butan-2-one (referred to as substance A) and of organic acid compound (referred to as substance B) is performed by calculating the synergy index (or FIC index) according to the following formula:

FIC Index=(MICa with B/MICa)+(MICb with A/MICb)

with:
MICa with B: minimum concentration of product A in the combination A+B which makes it possible to obtain an inhibitory effect
MICb with A: minimum concentration of product B in the combination A+B which makes it possible to obtain an inhibitory effect.
MICa: minimum inhibitory concentration of product A alone.
MICb: minimum inhibitory concentration of product B alone.

This formula was described for the first time in the article by F. C. Kull, P. C. Eisman, H. D. Sylwestrowka, and R. L. Mayer, Applied Microbiology 9:538-541, 1961.

For each compound tested alone, the MIC is considered as the first concentration which makes it possible to obtain a microbial growth percentage of less than or equal to 25%.

As regards the combinations tested, MICa with b and MICb with a are the respective concentrations of A and of B in the combinations which make it possible to obtain a microbial growth percentage of less than or equal to 25%.

### Interpretation of the FIC Index:

When the FIC index value is less than or equal to 1, it is considered that the combination of test compounds has a synergistic effect.

The results obtained are summarized in the following tables.

The combination of compounds A and B was tested on the following strains or a part thereof: Aspergillus niger, Enterococcus faecalis, Staphylococcus aureus, Pseudomonas aeruginosa, Candida albicans.

The microbial strain Aspergillus niger ATCC 6275, and a double-concentration Sabouraud broth liquid culture medium supplemented with polyoxyethylenated (20 OE) sorbitan monopalmitate (Tween 40 from Croda) and Phytagel© BioReagent were used (i.e. a mixture of 5 g of Phytagel+0.6 g Tween 40+60 g of Sabouraud broth).

The microbial strain Enterococcus faecalis ATCC 33186 and a double-concentration BHI (Brain Heart Infusion) broth liquid culture medium were used.

The microbial strain Staphylococcus aureus ATCC 6538 and a double-concentration nutritive broth liquid culture medium were used.

The microbial strain Pseudomonas aeruginosa ATCC 9027 and a double-concentration nutritive broth liquid culture medium were used.

The microbial strain Candida albicans ATCC 10231 and a double-concentration Sabouraud broth liquid culture medium were used.

A 96-well microplate and an incubation temperature of 32.5° C. are used.

The incubation time of the microplate is:
from 18 to 24 h under aerobic conditions for Candida albicans ATCC 10231, Pseudomonas aeruginosa ATCC 9027 and Staphylococcus aureus ATCC 6538;
from 24 to 30 h under aerobic conditions for microbial Aspergillus niger ATCC 6275;
from 24 to 48 h under aerobic conditions for Enterococcus faecalis ATCC 33186.

### Tests

For each compound:

A=4-(3-ethoxy-4-hydroxyphenyl)butan-2-one compound

B=organic acid compound

A 10% (weight/volume) stock solution was prepared by mixing 1 g of compound in 9 ml of aqueous 1‰ agar solution. Successive dilutions were made with the 1‰ agar solution.

Tests of Compounds A and B Alone

50 μl of each of the daughter solutions obtained containing compound A or B are added to the microplate wells. 100 μl of Sabouraud liquid nutrient broth inoculated at double concentration with the strain Candida albicans and 50 μl of aqueous 1‰ agar solution are also added thereto.

Tests of Compounds A and B as a Mixture

50 μl of each of the daughter solutions obtained containing compound A and 50 μl of each of the daughter solutions obtained containing compound B are added to the microplate wells. 100 μl of Sabouraud liquid nutrient broth inoculated at double concentration with the strain Candida albicans are also added thereto.

### Microbial Growth Control

A positive microbial growth control was also prepared. The positive microbial growth control corresponds to a mixture of 100 μl of aqueous 1‰ agar solution with 100 μl of Sabouraud liquid nutrient broth seeded at double concentration with the strain Candida albicans in the absence of compounds A and B.

### Absorbance Control of Compounds A and B Alone

An absorbance control was performed in parallel on compounds A and B alone. This control corresponds to 100 μl of double concentration sterile Sabouraud liquid nutrient broth+100 μl of double concentration compound A or B.

In the three cases (absorbance control, growth control and test), the final volume present in each of the microplate wells is 200 μl.

In the two cases (test and control), the inoculum represents the concentration of the strain Candida albicans present in the final volume of the wells (200 μl) and is between 2 and 6χ 10⁵ cfu/ml of Candida albicans.

The minimum inhibitory concentration (MIC) of each compound A and B alone and in combination was determined in a known manner by means of optical density measurements at a wavelength of 620 nm.

The test as described above (tests, absorbance controls and growth control) was performed again to test the combination A+B on the following strains Enterococcus faecalis, Staphylococcus aureus, Pseudomonas aeruginosa, Candida albicans.

The following results were obtained with compound B1=sodium benzoate:

Staphylococcus aureus

| concentra- | | | | | |
|---|---|---|---|---|---|
| tions tested | | | | | |
| (in weight | | | | | |
| %) | 0 of A | 0.0625 A | 0.125 A | 0.25 A | 0.5 A |
| 0 of B1 | | 67 | 65 | 55 | 5 |
| 0.0625 B1 | 51 | 48 | 37 | 41 | 42 |
| 0.125 B1 | 34 | 35 | 35 | 10 | 1 |
| | | | | (FIC 0.75) | |
| 0.25 B1 | 31 | 19 | 15 | 4 | 0 |
| | | (FIC 0.63) | (FIC 0.75) | (FIC 1) | |
| 0.5 B1 | 5 | 3 | 3 | 0 | 3 |
| % MIC | % MIC | MIC of each compound as | | | |
| of A | of B1 | a mixture | | FIC | |
| alone | alone | A % | B1 % | Index | |
| 0.5 | 0.5 | 0.0625 | 0.25 | 0.63 | Ratio A/ |
| | | | | | B1 = 0.25 |

The results obtained show synergistic inhibitory activity for the mixtures:

i) 0.0625% of A and 0.25% of B1, i.e. ratio A/B1=0.25
ii) 0.125% of A and 0.25% of B1, i.e. ratio A/B1=0.5
iii) 0.25% of A and 0.25% of B1, i.e. ratio A/B1=1
iv) 0.25% of A and 0.125% of B1, i.e. ratio A/B1=2
Candida albicans

| concentrations | | | | | |
|---|---|---|---|---|---|
| tested (in | | | | | |
| weight %) | 0 A | 0.025 A | 0.05 A | 0.1 A | |
| 0 B1 | | 55 | 31 | 19 | |
| 0.025 B1 | 55 | 41 | 33 | 17 | |
| 0.05 B1 | 33 | 27 | 19 | 10 | |
| | | | (FIC 0.5) | | |
| 0.1 B1 | 24 | 21 | 18 | 10 | |
| | | (FIC 0.75) | (FIC 1) | | |
| 0.2 B1 | 11 | 7 | 5 | 2 | |
| % MIC | % MIC | MIC of each compound | | | |
| of A | of B1 | as a mixture | | FIC | |
| alone | alone | A % | B1 % | Index | |
| 0.1 | 0.2 | 0.025 | 0.1 | 0.75 | Ratio A/ |
| | | | | | B1 = 0.25 |

The results obtained show synergistic inhibitory activity for the mixtures:

i) 0.025% of A and 0.1% of B1, i.e. ratio A/B1=0.25
ii) 0.05% of A and 0.1% of B1, i.e. ratio A/B1=0.5
iii) 0.05% of A and 0.05% of B1, i.e. ratio A/B1=1
Pseudomonas aeruginosa

| concentrations tested | | | | | | | |
|---|---|---|---|---|---|---|---|
| (in weight %) | | 0 A | 0.0625 A | 0.125 A | 0.25 A | 0.5 A | 1 A |
| 0 | B1 | | 133 | 142 | 79 | 74 | 22 |
| 0.0625 | B1 | 93 | 40 | 90 | 91 | 79 | 42 |
| 0.125 | B1 | 96 | 117 | 105 | 81 | 79 | 20 |
| 0.25 | B1 | 116 | 96 | 80 | 79 | 80 | 24 |
| 0.5 | B1 | 89 | 19 (FIC 0.56) | 19 (FIC 0.63) | 5 (FIC 0.75) | 0 (FIC 1) | 12 |
| 1 | B | 0 | 0 | 0 | 0 | 0 | 33 |

| % MIC of | % MIC of | MIC of each compound as a mixture | | FIC | |
|---|---|---|---|---|---|
| A alone | B1 alone | A % | B1% | Index | |
| 1 | 1 | 0.0625 | 0.5 | 0.56 | Ratio A/B1 = 0.125 |
| 0.25 | 0.5 | 0.0625 | 0.25 | 0.75 | Ratio A/B2 = 0.25 |

The results obtained show synergistic inhibitory activity for the mixtures:

i) 0.0625% of A and 0.5% of B1, i.e. ratio A/B1=0.125
ii) 0.125% of A and 0.5% of B1, i.e. ratio A/B1=0.25
iii) 0.25% of A and 0.5% of B1, i.e. ratio A/B1=0.5
iv) 0.5% of A and 0.5% of B1, i.e. ratio A/B1=1

### EXAMPLE 2: DETERMINATION OF THE SYNERGISTIC ANTIMICROBIAL ACTIVITY AS MIC

The demonstration of a synergistic antimicrobial activity effect with a mixture of 4-(3-ethoxy-4-hydroxyphenyl)butan-2-one (referred to as substance A) and of sorbic acid (referred to as substance B2) and a mixture of 4-(3-ethoxy-4-hydroxyphenyl)butan-2-one (referred to as substance A) and of potassium sorbate (referred to as substance B3) is carried out according to the protocol described in Example 1.

The combination of compounds A and B2 was tested on the following strains: Staphylococcus aureus, Candida albicans, Aspergillus niger, Enterococcus faecalis.

The combination of compounds A and B3 was tested on the following strains: Aspergillus niger, Enterococcus faecalis.

The following results were obtained:

A) Mixtures with Compound B2: Sorbic Acid
Staphylococcus aureus

| concentrations | | | | | |
|---|---|---|---|---|---|
| tested | | | | | |
| (in weight %) | 0 of A | 0.0625 A | 0.125 A | 0.25 A | 0.5 A |
| 0 de B2 | | 63 | 60 | 52 | 1 |
| 0.125 B2 | 52 | 59 | 62 | 47 | 1 |
| 0.25 B2 | 28 | 12 | 6 | 0 | 0 |
| | | (FIC 0.63) | (FIC 0.75) | (FIC 1) | |
| 0.5 B2 | −5 | 0 | 1 | 0 | 0 |
| | % MIC | MIC of each compound | | | |
| % MIC of | of B2 | as a mixture | | FIC | |
| A alone | alone | A % | B2 % | Index | |
| 0.5 | 0.5 | 0.0625 | 0.25 | 0.63 | Ratio A/ |
| | | | | | B2 = 0.25 |

The results obtained show synergistic inhibitory activity for the mixtures:

i) 0.0625% of A and 0.25% of B2, i.e. ratio A/B2=0.25
ii) 0.125% of A and 0.25% of B2, i.e. ratio A/B2=0.5
iii) 0.25% of A and 0.25% of B2, i.e. ratio A/B2=1
Candida albicans

| concentrations | | | | | |
|---|---|---|---|---|---|
| tested | | | | | |
| (in weight %) | 0 of A | 0.025 A | 0.05 A | 0.1 A | |
| 0 of B2 | | 56 | 41 | 16 | |
| 0.025 B2 | 37 | 31 | 24 | 18 | |
| 0.05 B2 | 24 | 11 | 12 | 8 | |
| | | (FIC 0.75) | (FIC 1) | | |
| 0.1 B2 | 21 | 20 | 14 | 6 | |
| | % MIC | MIC of each compound | | | |
| % MIC of | of B2 | as a mixture | | FIC | |
| A alone | alone | A % | B2 % | Index | |
| 0.1 | 0.1 | 0.025 | 0.05 | 0.75 | Ratio A/ |
| | | | | | B2 = 0.5 |

The results obtained show synergistic inhibitory activity for the mixtures:

i) 0.025% of A and 0.05% of B2, i.e. ratio A/B2=0.5
ii) 0.05% of A and 0.05% of B2, i.e. ratio A/B2=1
Aspergillus niger

| concentrations | | | | | |
|---|---|---|---|---|---|
| tested | | | | | |
| (in weight %) | 0 of A | 0.0625 A | 0.125 A | 0.25 A | |
| 0 of B2 | | 84 | 40 | 6 | |
| 0.0125 B2 | 98 | 89 | 37 | 5 | |
| 0.25 B2 | 95 | 2 | 3 | −2 | |
| | | (0.75) | (FIC 1) | | |
| 0.5 B2 | 8 | 0 | 1 | −4 | |
| | % MIC | MIC of each compound | | | |
| % MIC of | of B2 | as a mixture | | FIC | |
| A alone | alone | A % | B2 % | Index | |
| 0.25 | 0.5 | 0.0625 | 0.25 | 0.75 | Ratio A/ |
| | | | | | B2 = 0.25 |

The results obtained show synergistic inhibitory activity for the mixtures:

i) 0.0625% of A and 0.25% of B2, i.e. ratio A/B2=0.25
ii) 0.125% of A and 0.25% of B2, i.e. ratio A/B2=0.5
Enterococcus faecalis

| concentrations tested | | | | | | | |
|---|---|---|---|---|---|---|---|
| (in weight %) | | 0 of A | 0.0625 A | 0.125 A | 0.25 A | 0.5 A | 1 A |
| 0 of B2 | | | 82 | 86 | 105 | 100 | 15 |
| 0.25 | B2 | 53 | 91 | 75 | 5 | 100 | 5 |
| 0.5 | B2 | 78 | 42 | 0 (FIC 0.63) | 90 | 85 | 13 |
| 1 | B2 | 0 | 38 | 0 | 10 | 0 | −16 |

| % MIC of | % MIC of | MIC of each compound as a mixture | | FIC | |
|---|---|---|---|---|---|
| A alone | B2 alone | A % | B2% | Index | |
| 1 | 1 | 0.125 | 0.5 | 0.63 | Ratio A/B2 = 0.25 |

The results obtained show synergistic inhibitory activity for the mixture:

i) 0.125% of A and 0.5% of B2, i.e. ratio A/B2=0.25
B) Mixtures with compound B3: potassium sorbate
Enterococcus faecalis

| concentrations tested | | | | | | |
|---|---|---|---|---|---|---|
| (in weight %) | 0 A | 0.125 A | 0.25 A | 0.5 A | 1 A | 2A |
| 0 B3 | | 56 | 55 | 52 | 28 | 24 |
| 1 B3 | 22 | 19 (FIC 0.57) | 19 (FIC 0.63) | 13 (FIC 0.75) | 4 (FIC 1) | −1 |
| 2 B3 | 10 | 15 | 17 | 11 | −3 | 0 |

| % MIC of | % MIC of | MIC of each compound as a mixture | | FIC | |
|---|---|---|---|---|---|
| A alone | B3 alone | A % | B3% | Index | |
| 2 | 2 | 0.125 | 1 | 0.57 | Ratio A/B3 = 0.125 |

The results obtained show synergistic inhibitory activity for the mixtures:

i) 0.125% of A and 1% of B3, i.e. ratio A/B3=0.125

ii) 0.25% of A and 1% of B3, i.e. ratio A/B3=0.25
iii) 0.5% of A and 1% of B3, i.e. ratio A/B3=0.5
iv) 1% of A and 1% of B3, i.e. ratio A/B3=1
Aspergillus niger

| concentrations | | | | | |
|---|---|---|---|---|---|
| tested | | | | | |
| (in weight %) | 0 A | 0.025 A | 0.05 A | 0.1 A | |
| 0 B3 | | 65 | 40 | 15 | |
| 0.025 B3 | 58 | 44 | 12 | 21 | |
| | | | (FIC 0.75) | | |
| 0.05 B3 | 37 | 10 | 16 | 8 | |
| | | (FIC 0.75) | (FIC 1) | | |
| 0.1 B3 | 10 | 10 | 16 | 8 | |
| | % MIC | MIC of each compound | | | |
| % MIC of | of B3 | as a mixture | | FIC | |
| A alone | alone | A % | B3 % | Index | |
| 0.1 | 0.1 | 0.025 | 0.05 | 0.75 | Ratio A/ |
| | | | | | B3 = 0.5 |

The results obtained show synergistic inhibitory activity for the mixtures:
i) 0.025% of A and 0.05% of B3, i.e. ratio A/B3=0.5
ii) 0.05% of A and 0.05% of B3, i.e. ratio A/B3=1
iii) 0.05% of A and 0.025% of B3, i.e. ratio A/B3=2

### EXAMPLE 3

A facial care oil-in-water emulsion having the following composition was prepared (contents in weight percentages):

| Sorbitan tristearate (Span 65 V from Croda) | | 0.9% |
|---|---|---|
| Glyceryl mono/distearate (36/64)/potassium stearate mixture | | 3% |
| (Tegin Pellets from Goldschmidt) | | |
| Polyethylene glycol stearate (40 ethylene oxide units) | | 2% |
| 4-(3-ethoxy-4-hydroxyphenyl)butan-2-one | | 0.05% |
| Potassium sorbate | | 0.2% |
| Propane-1,3-diol | | 3% |
| Mixture of mineral oil, microcrystalline wax and paraffin | | 4% |
| (Vaseline Blanche Codex 236 from Aiglon) | | |
| Liquid fraction of shea butter (Shea Olein from Olvea) | | 1% |
| Cyclopentadimethylsiloxane | | 5% |
| Cetyl alcohol | | 4% |
| Apricot kernel oil | | 0.3% |
| Hydrogenated polyisobutene (Parleam from NOF Corporation) | | 7.2% |
| Myristyl myristate | | 2% |
| Stearic acid | | 1.2% |
| Caffeine | | 0.1% |
| Citric acid | | 0.2% |
| Glycerol | | 3% |
| Sodium hydroxide | | 0.05% |
| Water | qs | 100% |

### EXAMPLE 4: DETERMINATION OF THE SYNERGISTIC ANTIMICROBIAL ACTIVITY AS MIC

The demonstration of a synergistic antimicrobial activity effect with a mixture of 4-(3-ethoxy-4-hydroxyphenyl)butan-2-one (referred to as substance A) and of methyl 4-hydroxybenzoate (referred to as substance B4) and a mixture of 4-(3-ethoxy-4-hydroxyphenyl)butan-2-one (referred to as substance A) and of propyl 4-hydroxybenzoate (referred to as substance B5) is carried out according to the protocol described in Example 1.

The combination of compounds A and B4 was tested on the following strains: Staphylococcus aureus, Candida albicans, and Pseudomonas aeruginosa.

The combination of compounds A and B5 was tested on the following strains: Candida albicans, and Pseudomonas aeruginosa.

The following results were obtained:

A) Mixtures with Compound B4: Methyl 4-Hydroxybenzoate
Staphylococcus aureus

| Concentrations | | | | | |
|---|---|---|---|---|---|
| tested | | | | | |
| (in weight %) | 0 A | 0.0625 A | 0.125 A | 0.25 A | 0.5 A |
| 0 B4 | | 66 | 61 | 51 | 1 |
| 0.25 B4 | 51 | 60 | 55 | 51 | 1 |
| 0.5 B4 | 44 | 16 | 14 | 6 | 3 |
| | | (FIC 0.63) | (FIC 0.75) | (FIC 1) | |
| 1 B4 | 19 | 1 | 1 | 3 | 2 |
| | % MIC | MIC of each compound | | | |
| % MIC of | of B4 | as a mixture | | FIC | |
| A alone | alone | A % | B4 % | Index | |
| 0.5 | 1 | 0.0625 | 0.5 | 0.63 | Ratio A/ |
| | | | | | B4 = 0.125 |

The results obtained show synergistic inhibitory activity for the mixtures:

i) 0.0625% of A and 0.5% of B4, i.e. ratio A/B4=0.125
ii) 0.125% of A and 0.5% of B4, i.e. ratio A/B4=0.25
iii) 0.25% of A and 0.5% of B4, i.e. ratio A/B4=0.5
Candida albicans

| concentrations | | | | | |
|---|---|---|---|---|---|
| tested | | | | | |
| (in weight %) | 0 A | 0.025 A | 0.05 A | 0.1 A | |
| 0 B4 | | 61 | 38 | 18 | |
| 0.025 B4 | 67 | 53 | 36 | 19 | |
| 0.05 B4 | 40 | 38 | 20 | 12 | |
| | | | (FIC 0.75) | | |
| 0.1 B4 | 28 | 23 | 15 | 10 | |
| | | (FIC 0.75) | (FIC 1) | | |
| 0.2 B4 | 12 | 6 | 1 | 1 | |
| | % MIC | MIC of each compound | | | |
| % MIC of | of B4 | as a mixture | | FIC | |
| A alone | alone | A % | B4 % | Index | |
| 0.1 | 0.2 | 0.05 | 0.05 | 0.75 | Ratio A/ |
| | | | | | B4 = 1 |

The results obtained show synergistic inhibitory activity for the mixtures:

i) 0.025% of A and 0.1% of B4, i.e. ratio A/B4=0.25
ii) 0.05% of A and 0.1% of B4, i.e. ratio A/B4=0.5
iii) 0.05% of A and 0.05% of B4, i.e. ratio A/B4=1
Pseudomonas aeruginosa

| concentrations tested | | | | | | | |
|---|---|---|---|---|---|---|---|
| (in weight %) | | 0 A | 0.0625 A | 0.125 A | 0.25 A | 0.5 A | 1 A |
| 0 | B4 | | 37 | 52 | 78 | 52 | 24 |
| 0.0625 | B4 | 187 | 135 | 113 | 101 | 66 | 3 |
| 0.125 | B4 | 150 | 61 | 166 | 115 | 43 | 24 |
| 0.25 | B4 | 142 | 99 | 4 (FIC 0.63) | 1 (FIC 0.75) | 0 (FIC 1) | −4 |
| 0.5 | B4 | 1 | 0 | 0 | 0 | 0 | 34 |

| % MIC of | % MIC of | MIC of each compound as a mixture | | FIC | |
|---|---|---|---|---|---|
| A alone | B4 alone | A % | B4% | Index | |
| 1 | 0.5 | 0.125 | 0.25 | 0.63 | Ratio A/B4 = 0.5 |

The results obtained show synergistic inhibitory activity for the mixtures:

i) 0.125% of A and 0.25% of B4, i.e. ratio A/B4=0.5
ii) 0.25% of A and 0.25% of B4, i.e. ratio A/B4=1
iii) 0.5% of A and 0.25% of B4, i.e. ratio A/B4=2
B) Mixtures with Compound B5: Propyl 4-Hydroxybenzoate
Candida albicans

| concentrations | | | | | |
|---|---|---|---|---|---|
| tested | | | | | |
| (in weight %) | 0 A | 0.025 A | 0.05 A | 0.1 A | |
| 0 B5 | | 56 | 39 | 18 | |
| 0.025 B5 | 52 | 43 | 32 | 19 | |
| 0.05 B5 | 33 | 20 | 11 | 7 | |
| | | (FIC 0.75) | (FIC 1) | | |
| 0.1 B5 | 21 | 13 | 6 | 2 | |
| | % MIC | MIC of each compound | | | |
| % MIC of | of B5 | as a mixture | | FIC | |
| A alone | alone | A % | B5 % | Index | |
| 0.1 | 0.1 | 0.025 | 0.05 | 0.75 | Ratio A/ |
| | | | | | B5 = 0.5 |

The results obtained show synergistic inhibitory activity for the mixtures:

i) 0.025% of A and 0.05% of B5, i.e. ratio A/B5=0.5
ii) 0.05% of A and 0.05% of B5, i.e. ratio A/B5=1
Pseudomonas aeruginosa

| concentrations tested | | | | | | | |
|---|---|---|---|---|---|---|---|
| (in weight %) | | 0 A | 0.0625 A | 0.125 A | 0.25 A | 0.5 A | 1 A |
| 0 | B5 | | 117 | 54 | 87 | 64 | 45 |
| 0.125 | B5 | 76 | 58 | 113 | 58 | 65 | 67 |
| 0.25 | B5 | 45 | 36 | 31 | 25 | 20 (FIC ≤ 0.75) | 14 (FIC ≤ 1) |
| 0.5 | B5 | 42 | 57 | 38 | 47 | −23 (FIC ≤ 1) | −3 |
| 1 | B5 | 24 | 0 | 33 | −18 | −17 | 8 |

| % MIC of | % MIC of | MIC of each compound as a mixture | | FIC | |
|---|---|---|---|---|---|
| A alone | B5 alone | A % | B5% | Index | |
| ≥1 | 1 | 0.5 | 0.25 | ≤0.75 | Ratio A/B5 = 2 |

The results obtained show synergistic inhibitory activity for the mixtures:

i) 0.5% of A and 0.5% of B5, i.e. ratio A/B5=1
ii) 1% of A and 0.5% of B5, i.e. ratio A/B5=2
iii) 0.5% of A and 0.25% of B5, i.e. ratio A/B5=2
iv) 1% of A and 0.25% of B5, i.e. ratio A/B5=4

### C)

It was moreover noted that the following mixtures:
mixture of 4-(3-ethoxy-4-hydroxyphenyl)butan-2-one with ethyl 4-hydroxybenzoate,
mixture of 4-(3-ethoxy-4-hydroxyphenyl)butan-2-one with butyl 4-hydroxybenzoate,
   tested in the same tests described previously have no synergistic antimicrobial activity.

### EXAMPLE 5: DETERMINATION OF THE SYNERGISTIC ANTIMICROBIAL ACTIVITY AS MIC

The demonstration of a synergistic antimicrobial activity effect with a mixture of 4-(3-ethoxy-4-hydroxyphenyl)butan-2-one (referred to as substance A) and of 5-n-octanoylsalicylic acid (referred to as substance B6) is performed according to the method described in Example 1.

The following results were obtained:

Candida albicans

| concen- | | | | | |
|---|---|---|---|---|---|
| trations | | | | | |
| tested (in | | | | | |
| weight %) | 0 A | 0.025 A | 0.05 A | 0.1 A | 0.2 A |
| 0 B6 | | 74 | 69 | 36 | 6 |
| 0.0125 B6 | 66 | 48 | 37 | 13 | 1 |
| | | | | (FIC 0.625) | |
| 0.025 B6 | 40 | 31 | 24 | 3 | 1 |
| | | | (FIC 0.5) | (FIC 0.75) | |
| 0.05 B6 | 30 | 6 | 5 | 1 | 0 |
| | | (FIC 0.625) | (FIC 0.75) | (FIC 1) | |
| 0.1 B6 | 1 | −3 | 0 | −3 | −1 |
| | % MIC | MIC of each compound | | | |
| % MIC of | of B6 | as a mixture | | FIC | |
| A alone | alone | A % | B6 % | Index | |
| 0.2 | 0.1 | 0.05 | 0.025 | 0.5 | Ratio A/ |
| | | | | | B6 = 2 |

The results obtained show synergistic inhibitory activity for the mixtures:

i) 0.0625% of A and 0.05% of B6, i.e. ratio A/B6=0.5
ii) 0.05% of A and 0.05% of B6, i.e. ratio A/B6=1
iii) 0.1% of A and 0.05% of B6, i.e. ratio A/B6=2
iv) 0.05% of A and 0.025% of B6, i.e. ratio A/B6=2
v) 0.1% of A and 0.025% of B6, i.e. ratio A/B6=4
vi) 0.1% of A and 0.0125% of B6, i.e. ratio A/B6=8
Aspergillus niger

| concentrations tested | | | | | | | |
|---|---|---|---|---|---|---|---|
| (in weight %) | | 0 A | 0.0025 A | 0.05 A | 0.1 A | 0.2 A | 0.4 A |
| 0 | B6 | | 84 | 40 | 6 | 59 | 5 |
| 0.025 | B6 | 98 | 111 | 103 | 97 | 10 (FIC 0.75) | 4 |
| 0.05 | B6 | 97 | 75 | 63 | 68 | 6 (FIC 1) | 4 |
| 0.1 | B6 | 17 | 17 | 8 | 5 | 3 | 0 |

| % MIC of | % MIC of | MIC of each compound as a mixture | | FIC | |
|---|---|---|---|---|---|
| A alone | B6 alone | A % | B6% | Index | |
| 0.4 | 0.1 | 0.2 | 0.025 | 0.75 | Ratio A/B6 = 8 |

The results obtained show synergistic inhibitory activity for the mixtures:

i) 0.2% of A and 0.05% of B6, i.e. ratio A/B6=4
ii) 0.2% of A and 0.025% of B6, i.e. ratio A/B6=8
Enterococcus faecalis

| concentrations tested | | | | | | | |
|---|---|---|---|---|---|---|---|
| (in weight %) | | 0 A | 0.0625 A | 0.125 A | 0.25 A | 0.5 A | 1 A |
| 0 | B6 | | 35 | 40 | 41 | 36 | 16 |
| 0.0125 | B6 | 28 | 26 | 20 (FIC 0.625) | 18 (FIC 0.75) | 21 (FIC 1) | −2 |
| 0.025 | B6 | 2 | 2 | 1 | 2 | 2 | −19 |

| % MIC of | % MIC of | MIC of each compound as a mixture | | FIC | |
|---|---|---|---|---|---|
| A alone | B6 alone | A % | B6% | Index | |
| 1 | 0.025 | 0.125 | 0.0125 | 0.63 | Ratio A/B6 = 10 |

The results obtained show synergistic inhibitory activity for the mixture:

i) 0.125% of A and 0.0125% of B6, i.e. ratio A/B6=10
ii) 0.25% of A and 0.0125% of B6, i.e. ratio A/B6=20
iii) 0.5% of A and 0.0125% of B6, i.e. ratio A/B6=40

### EXAMPLE 6: DETERMINATION OF THE SYNERGISTIC ANTIMICROBIAL ACTIVITY AS MIC

The demonstration of a synergistic antimicrobial activity effect with a mixture of 4-(3-ethoxy-4-hydroxyphenyl)butan-2-one (referred to as substance A) and of caprylhydroxamic acid (referred to as substance B7) is performed according to the method described in Example 1.

The combination of compounds A and B7 was tested on the Aspergillus niger strain.

For B7, use was made of B′=caprylhydroxamic acid (compound B7) at 7.5% by weight in 1,3-propanediol (sold under the name Zeastat by the company Inolex Chemical).

The following results were obtained:

Aspergillus niger

| Concentrations | | | | | |
|---|---|---|---|---|---|
| tested | | | | | |
| (in weight %) | 0 A | 0.025 A | 0.05 A | 0.1 A | 0.2 A |
| 0 B′ | | 62 | 32 | 25 | 10 |
| 0.0125 B′ | 79 | 36 | 23 | 8 | 6 |
| | | | | (FIC 0.63) | |
| 0.025 B′ | 57 | 22 | 16 | 11 | 10 |
| | | | (FIC 0.63) | (FIC 0.75) | |
| 0.05 B′ | 28 | 16 | 14 | 4 | −3 |
| | | (FIC 0.63) | (FIC 0.75) | (FIC 1) | |
| 0.1 B′ | 13 | 8 | 10 | 3 | 6 |
| | | | | | Ratio |
| | % MIC | MIC of each compound | | | A/B′ |
| % MIC of | of B′ | as a mixture | | FIC | (Ratio |
| A alone | alone | A % | B′ % | Index | A/B7) |
| 0.2 | 0.1 | 0.025 | 0.05 | 0.63 | 0.5 |
| | | | | | (6.7) |

The results obtained show synergistic inhibitory activity for the mixtures:

i) 0.025% of A and 0.05% of B′ (3.75 10⁻³% of B7), i.e. ratio A/B7=6.7
ii) 0.05% of A and 0.05% of B′ (3.75 10⁻³% of B7), i.e. ratio A/B7=13.3
iii) 0.1% of A and 0.05% of B′ (3.75 10⁻³% of B7), i.e. ratio A/B7=26.7
iv) 0.05% of A and 0.025% of B′ (1.875 10⁻³% of B7), i.e. ratio A/B7=26.7
v) 0.1% of A and 0.025% of B′ (1.875 10⁻³% of B7), i.e. ratio A/B7=53.3
vi) 0.1% of A and 0.0125% of B′ (0.94 10⁻³% of B7), i.e. ratio A/B7=106

### EXAMPLE 7: DETERMINATION OF THE ANTIMICROBIAL ACTIVITY OF THE ANTIMICROBIAL MIXTURE

The antimicrobial efficacy of the 4-(3-ethoxy-4-hydroxyphenyl)butan-2-one+caprylhydroxamic acid antimicrobial mixture (respective weight ratio of 0.16) was evaluated by the Challenge Test method.

### Cosmetic Formula

A facial care oil-in-water emulsion having the following composition was prepared (contents in weight percentages):

| Sorbitan tristearate (Span 65 V from Croda) | | 0.9% |
|---|---|---|
| Glyceryl mono/distearate (36/64)/potassium stearate mixture | | 3% |
| (Tegin Pellets from Goldschmidt) | | |
| Polyethylene glycol stearate (40 ethylene oxide units) | | 2% |
| 4-(3-ethoxy-4-hydroxyphenyl)butan-2-one | | 0.15% |
| Caprylhydroxamic acid in solution at 7.5% by weight | | 1.5% |
| in 1,3-propanediol | | |
| Propane-1,3-diol | | 2% |
| Mixture of mineral oil, microcrystalline wax and paraffin | | 4% |
| (Vaseline Blanche Codex 236 from Aiglon) | | |
| Liquid fraction of shea butter (Shea Olein from Olvea) | | 1% |
| Cyclopentadimethylsiloxane | | 5% |
| Cetyl alcohol | | 4% |
| Apricot kernel oil | | 0.3% |
| Hydrogenated polyisobutene (Parleam from NOF Corporation) | | 7.2% |
| Myristyl myristate | | 2% |
| Stearic acid | | 1.2% |
| Caffeine | | 0.1% |
| Citric acid | | 0.2% |
| Glycerol | | 3% |
| Sodium hydroxide | | 0.05% |
| Water | qs | 100% |

Control formula A: Formulation similar to the preceding one containing 0.15% of 4-(3-ethoxy-4-hydroxyphenyl)butan-2-one and without caprylhydroxamic acid (1.5% compensated with water)
Control formula B: Similar formula containing 1.5% of caprylhydroxamic acid (in solution with 1,3-propanediol) and without 4-(3-ethoxy-4-hydroxyphenyl)butan-2-one (0.15% compensated with water)

### Microorganism Cultures

5 pure cultures of microorganisms were used.

| MICROORGANISMS | Subculturing medium | T° | ATCC |
|---|---|---|---|
| Escherichia coli (Ec) | Trypto-casein soya | 35° C. | 8739 |
| Enterococcus faecalis (Ef) | Trypto-casein soya | 35° C. | 33186 |
| Pseudomonas aeruginosa (Pa) | Trypto-casein soya | 35° C. | 19429 |
| Candida albicans (Ca) | Sabouraud | 35° C. | 10231 |
| Aspergillus niger (An) | Malt | 35° C. | 6275 |

ATCC = American Type Culture Collection

The strains of gram-negative bacteria (Escherichia coli and Pseudomonas aeruginosa), gram-positive bacterium (Enterococcus faecalis), yeast (Candida albicans), and mould (Aspergillus niger) are inoculated into subculturing medium, respectively the day before inoculation for the bacteria and the yeast, and 5 days before inoculation for the mould.

On the day of inoculation:
a suspension in tryptone salt diluent is prepared, respectively, for the bacteria and the yeast, so as to obtain by spectrophotometer a suspension with an optical density of between 35% and 45% of transmitted light at 544 nm;
for the mould, the spores are collected by washing the agar with 6 to 7 ml of harvesting solution and the suspension is recovered in a sterile tube or flask.

After homogenizing the microbial suspension, 0.2 ml of inoculum is introduced into each pill bottle (the suspensions are used pure: between 1×10⁸ and 3×10⁸ cfu per ml) and the microbial suspension in the 20 g of product (=cosmetic formula) is homogenized thoroughly using a spatula.

The content of microorganisms present in the product corresponds after homogenization to a concentration of 10⁶ microorganisms per gram of product, i.e. inoculation to 1% of an inoculum containing 10⁸ microorganisms per ml.

After 7 days of contact time between the microorganisms and the product at 22° C.±2° C. and in the dark, ten-fold dilutions are performed and the number of revivable microorganisms remaining in the product is counted.

### Results

| | No. of CFU/gram of product at T7 days | | | | |
|---|---|---|---|---|---|
| | E. coli | P. aeruginosa | E. faecalis | C. albicans | A. niger |
| Antimicrobial | <200 | <200 | <200 | <200 | 2 E3 |
| mixture | | | | | |

<200 CFU: sensitivity threshold of the method

### EXAMPLE 8: DETERMINATION OF THE SYNERGISTIC ANTIMICROBIAL ACTIVITY AS MIC

The demonstration of a synergistic antimicrobial activity effect with a mixture of 4-(3-ethoxy-4-hydroxyphenyl)butan-2-one (referred to as substance A) and of sodium dehydroacetate (referred to as substance B8) is performed according to the protocol described in Example 1.

The following results were obtained:

Candida albicans

| Concentrations | | | | | |
|---|---|---|---|---|---|
| tested | | | | | |
| (in weight %) | 0 A | 0.025 A | 0.05 A | 0.1 A | |
| 0 B8 | | 53 | 35 | 18 | |
| 0.00125 B8 | 28 | 19 | 13 | 8 | |
| | | (FIC 0.75) | (FIC 1) | | |
| 0.0025 B8 | 15 | 8 | 6 | 3 | |
| | % MIC | MIC of each compound | | | |
| % MIC of | of B8 | as a mixture | | FIC | |
| A alone | alone | A % | B8 % | Index | |
| 0.1 | 0.0025 | 0.025 | 0.000125 | 0.75 | Ratio A/ |
| | | | | | B8 = 20 |

The results obtained show synergistic inhibitory activity for the mixtures:

i) 0.025% of A and 0.00125% of B8, i.e. ratio A/B8=20
ii) 0.05% of A and 0.00125% of B8, i.e. ratio A/B8=40
Aspergillus niger

| Concentrations | | | | | |
|---|---|---|---|---|---|
| tested | | | | | |
| (in weight %) | 0 A | 0.0625 A | 0.125 A | 0.25 A | |
| 0 B8 | | 96 | 41 | 7 | |
| 0.0025 B8 | 97 | 69 | 29 | 4 | |
| 0.005 B8 | 29 | 12 | 3 | 2 | |
| | | (FIC 0.5) | (FIC 0.75) | | |
| 0.01 B8 | 3 | 2 | 2 | 2 | |
| | | (FIC 0.75) | (FIC 1) | | |
| 0.02 B8 | 3 | 2 | 2 | 2 | |
| | % MIC | MIC of each compound | | | |
| % MIC of | of B8 | as a mixture | | FIC | |
| A alone | alone | A % | B8 % | Index | |
| 0.25 | 0.02 | 0.0625 | 0.01 | 0.75 | Ratio A/ |
| | | | | | B8 = 6.25 |

The results obtained show synergistic inhibitory activity for the mixtures:

i) 0.0625% of A and 0.01% of B8, i.e. ratio A/B8=6.25
ii) 0.125% of A and 0.01% of B8, i.e. ratio A/B8=12.5
iii) 0.0625% of A and 0.005% of B8, i.e. ratio A/B8=12.5
iv) 0.125% of A and 0.005% of B8, i.e. ratio A/B8=25

1. A synergistic antimicrobial mixture comprising 4-(3-ethoxy-4-hydroxyphenyl)butan-2-one and an organic acid compound chosen from:
i) a benzoic acid salt in an amount such that the 4-(3-ethoxy-4-hydroxyphenyl)butan-2-one/benzoic acid salt weight ratio ranges from 0.1 to 3;
ii) sorbic acid or a salt thereof in an amount such that the 4-(3-ethoxy-4-hydroxyphenyl)butan-2-one/sorbic acid or salt thereof weight ratio ranges from 0.1 to 2.5;
iii) 5-n-octanoylsalicylic acid in an amount such that the 4-(3-ethoxy-4-hydroxyphenyl)butan-2-one/5-n-octanoylsalicylic acid weight ratio ranges from 0.5 to 60;
iv) a hydroxamic acid or a salt thereof, of formula (I):
R—C(═O)—NH—OH (I)
in which R represents a linear or branched, saturated or unsaturated C₅ to C₁₁ alkyl radical in an amount such that the 4-(3-ethoxy-4-hydroxyphenyl)butan-2-one/hydroxamic acid (I) or salt thereof weight ratio ranges from 4 to 150;
vi) dehydroacetic acid or a salt thereof in an amount such that the weight ratio of 4-(3-ethoxy-4-hydroxyphenyl)butan-2-one/dehydroacetic acid or salt thereof ranges from 4 to 60; and
wherein the amounts of the 4-(3-ethoxy-4-hydroxyphenyl)butan-2-one and organic acid compound provide synergistic antimicrobial activity.

2. The antimicrobial mixture according to claim 1, wherein the organic acid compound is a benzoic acid salt.

3. The antimicrobial mixture according to claim 1, wherein the benzoic acid salt is chosen from alkali metal salts, alkaline-earth metal salts, the monoethanolamine salt and the ammonium salt.

4. The antimicrobial mixture according to claim 2, wherein the benzoic acid salt is the sodium salt.

5. The antimicrobial mixture according to claim 2, which comprises 4-(3-ethoxy-4-hydroxyphenyl)butan-2-one and benzoic acid or a salt thereof in amounts such that the 4-(3-ethoxy-4-hydroxyphenyl)butan-2-one/benzoic acid salt weight ratio ranges from 0.1 to 1.5.

6. The antimicrobial mixture according to claim 1, wherein the organic acid compound is sorbic acid or a salt thereof.

7. The antimicrobial mixture according to claim 6, wherein the sorbic acid salt is chosen from alkali metal salts, alkaline-earth metal salts and the triethanolamine salt.

8. The antimicrobial mixture according to claim 6, which comprises 4-(3-ethoxy-4-hydroxyphenyl)butan-2-one and sorbic acid or a salt thereof in amounts such that the 4-(3-ethoxy-4-hydroxyphenyl)butan-2-one/sorbic acid or a salt thereof weight ratio ranges from 0.1 to 1.5.

9. The antimicrobial mixture according to claim 6, wherein the antimicrobial mixture comprises sorbic acid.

10. The antimicrobial mixture according to claim 9, which has a 4-(3-ethoxy-4-hydroxyphenyl)butan-2-one/sorbic acid weight ratio ranging from 0.1 to 1.5.

11. The antimicrobial mixture according to claim 9, which has a 4-(3-ethoxy-4-hydroxyphenyl)butan-2-one/sorbic acid weight ratio ranging from 0.4 to 1.2.

12. The antimicrobial mixture according to claim 9, which has a 4-(3-ethoxy-4-hydroxyphenyl)butan-2-one/sorbic acid weight ratio ranging from 0.1 to 0.8.

13. The antimicrobial mixture according to claim 9, which has a 4-(3-ethoxy-4-hydroxyphenyl)butan-2-one/sorbic acid weight ratio ranging from 0.15 to 0.4.

14. The antimicrobial mixture according to claim 6, wherein the antimicrobial mixture comprises potassium sorbate.

15. The antimicrobial mixture according to claim 14, which has a 4-(3-ethoxy-4-hydroxyphenyl)butan-2-one/potassium sorbate weight ratio ranging from 0.1 to 1.5.

16. The antimicrobial mixture according to claim 14, which has a 4-(3-ethoxy-4-hydroxyphenyl)butan-2-one/potassium sorbate weight ratio ranging from 0.3 to 2.5.

17. The antimicrobial mixture according to claim 1, wherein the organic acid compound is 5-n-octanoylsalicylic acid.

18. The antimicrobial mixture according to claim 17, which comprises 4-(3-ethoxy-4-hydroxyphenyl)butan-2-one and 5-n-octanoylsalicylic acid in amounts such that the 4-(3-ethoxy-4-hydroxyphenyl)butan-2-one/5-n-octanoylsalicylic acid weight ratio ranges from 0.5 to 50.

19. The antimicrobial mixture according to claim 17, which has a 4-(3-ethoxy-4-hydroxyphenyl)butan-2-one/5-n-octanoylsalicylic acid weight ratio ranging from 3 to 12.

20. The antimicrobial mixture according to claim 17, which has a 4-(3-ethoxy-4-hydroxyphenyl)butan-2-one/5-n-octanoylsalicylic acid weight ratio ranging from 0.5 to 12.

21. The antimicrobial mixture according to claim 17, which has a 4-(3-ethoxy-4-hydroxyphenyl)butan-2-one/5-n-octanoylsalicylic acid weight ratio ranging from 7 to 60.

22. The antimicrobial mixture according to claim 1, wherein the organic acid compound is hydroxamic acid of formula (I).

23. The antimicrobial mixture according to claim 22, wherein said hydroxamic acid is chosen from caprohydroxamic acid, caprylhydroxamic acid, caprihydroxamic acid and laurylhydroxamic acid, and mixtures thereof.

24. The antimicrobial mixture according to claim 22, wherein the hydroxamic acid is caprylhydroxamic acid.

25. The antimicrobial mixture according to claim 22, which comprises 1,3-propanediol.

26. The antimicrobial mixture according to claim 25, wherein the 1,3-propanediol is present according to a 1,3-propanediol/hydroxamic acid (I) weight ratio ranging from 5 to 20.

27. The antimicrobial mixture according to claim 22, which comprises 4-(3-ethoxy-4-hydroxyphenyl)butan-2-one and the hydroxamic acid (I) in amounts such that the 4-(3-ethoxy-4-hydroxyphenyl)butan-2-one/hydroxamic acid (I) weight ratio ranges from 30 to 130.

28. The antimicrobial mixture according to claim 1, wherein the organic acid compound is dehydroacetic acid or a salt thereof.

29. The antimicrobial mixture according to claim 28, wherein the dehydroacetic acid salt is chosen from alkali metal salts.

30. The antimicrobial mixture according to claim 28, which contains sodium dehydroacetate.

31. The antimicrobial mixture according to claim 28, which comprises 4-(3-ethoxy-4-hydroxyphenyl)butan-2-one and dehydroacetic acid or a salt thereof in amounts such that the weight ratio of 4-(3-ethoxy-4-hydroxyphenyl)butan-2-one/dehydroacetic acid or a salt thereof ranges from 5 to 50.

32. The antimicrobial mixture according to claim 30, which has a 4-(3-ethoxy-4-hydroxyphenyl)butan-2-one/sodium dehydroacetate weight ratio ranging from 10 to 60.

33. The antimicrobial mixture according to claim 30, which has a 4-(3-ethoxy-4-hydroxyphenyl)butan-2-one/sodium dehydroacetate weight ratio ranging from 4 to 40.

34. A composition comprising, in a physiologically acceptable medium, an antimicrobial mixture according to claim 1.

35. The composition according to claim 34, wherein it comprises at least one additional ingredient chosen from water, oils, polyols containing from 2 to 10 carbon atoms, gelling agents, surfactants, film-forming polymers, colorants, fragrances, fillers, UV-screening agents, plant extracts, cosmetic and dermatological active agents, and salts.

36. The composition according to claim 34, wherein the 4-(3-ethoxy-4-hydroxyphenyl)butan-2-one is present in a content ranging from 0.01% to 5% by weight relative to the total weight of the composition.

37. A method for the conservation of a composition comprising a physiologically acceptable medium which comprises including an antimicrobial mixture according to claim 1 in the composition.
